(19) United States
(12) Patent Application Publication
(10) Pub. No.: US 2009/0168449 A1
(43) Pub. Date: Jul. 2, 2009

(54) Light emitting diode unit

(75) Inventors: Ho-Joon Park, Seoul (KR); Jun-Rok Oh, Seoul (KR); Jin-Cheol Kim, Hwaseong-si (KR); Sang-Jun Yoon, Seoul (KR); Hwa-Young Lee, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/155,931

(22) Filed: Jun. 11, 2008

(30) Foreign Application Priority Data
Dec. 27, 2007 (KR) 10-2007-0138392

(51) Int. Cl. F21V 7/04

(52) U.S. Cl. 362/555

(57) ABSTRACT

Disclosed is a light emitting diode unit, more particularly, a light emitting diode unit including a thermoplastic substrate, a light emitting diode, mounted on one surface of the thermoplastic substrate and a heat sink, directly adhered to the other surface of the thermoplastic substrate. With the present invention, the manufacturing cost and the manufacturing time of the light emitting diode unit can be reduced by allowing the heat sink, discharging the heat generated by the light emitting diode, to be directly adhered to the substrate on which the light emitting diode is mounted. Also, the heat discharging ability of the light emitting diode unit by using the heat sink directly adhered to the thermoplastic substrate.

### CROSS-REFERENCE TO RELATED APPLICATIONS

This application claims the benefit of Korean Patent Application No. 10-2007-0138392 filed with the Korean Intellectual Property Office on Dec. 27, 2007, the disclosure of which is incorporated herein by reference in its entirety.

### BACKGROUND

1. Technical Field

The present invention relates to a light-emitting diode unit.

2. Description of the Related Art

Light emitting diode units are becoming increasingly popular. This is because the light emitting diode unit is possible to generate relatively brighter light by using a relatively low power. Also, its good durability helps to spread the light emitting diode units.

The light emitting diode unit can be manufactured by mounting light emitting diodes on a printed circuit board. The light diode unit generates light by supplying an electric signal to the light emitting diodes.

The efficient discharge of the heat generated when light is emitted is one of important factors to improve the durability. Herein a heat sink, for example, can be applied to the light emitting diode in order to improve the heat discharging ability of the printed circuit board having one surface on which the light emitting diode is mounted.

However, the printed circuit board made of an epoxy resin has a low level of adhesion to the heat sink. This weak adhesion may cause the printed circuit board to be bended.

### SUMMARY

The present invention provides a light emitting diode unit that can include a thermoplastic substrate, in direct contact with a heat sink, in order to reduce a manufacture cost and enhance the light emitting efficiency.

An aspect of the invention features a light emitting diode unit including a thermoplastic substrate; a light emitting diode, mounted on one surface of the thermoplastic substrate; and a heat sink, directly adhered to the other surface of the thermoplastic substrate.

In this case, the thermoplastic substrate can be made based on one of a liquid crystal polymer, a Polyetherimide (PEI), a Polyethersulfone (PES), a Polyetheretherketone (PEEK) and a Polytetrafluoroethylene (PTFE) or a combination thereof.

Also, the heat sink can be made of a metal. Since the heat sink made of the metal does not have the enough adhesion to a substrate made of a thermoplastic resin, it is impossible to guarantee the heat discharging ability of the light emitting diode. With the present invention, the adhesion to the metal plate can be stably provided by using the thermoplastic substrate.

The thermoplastic substrate can also include scattered ceramic filters. Improving the heat conduction of the substrate makes it possible to allow a ceramic filler to efficiently discharge the heat generated by the light emitting diode.

The thermoplastic substrate can include scattered glass fibers. The glass fiber can enhance the rigidity of the substrate.

The thermoplastic substrate can include a glass fiber cloth formed by the weave of a weft and a warp including a plurality of glass fiber twists.

Additional aspects of the present invention will be set forth in part in the description which follows, and in part will be obvious from the description, or may be learned by practice of the invention.

### BRIEF DESCRIPTION OF THE DRAWINGS

FIG. 1 is a sectional view showing a light emitting diode unit according to an embodiment of the present invention;

FIG. 2 is a sectional view showing a light emitting diode unit according to another embodiment of the present invention; and

FIG. 3 is a sectional view showing a light emitting diode unit according to another embodiment of the present invention.

### DETAILED DESCRIPTION

As the invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In the description of the present invention, certain detailed explanations of related art are omitted when it is deemed that they may unnecessarily obscure the essence of the invention.

While such terms as “first,” “second,” etc., may be used to describe various elements, such elements must not be limited to the above terms. The above terms are used only to distinguish one element from another.

The terms used in the present specification are merely used to describe particular embodiments, and are not intended to limit the present invention. An expression used in the singular encompasses the expression of the plural, unless it has a clearly different meaning in the context. In the present specification, it is to be understood that the terms such as “including” or “having,” etc., are intended to indicate the existence of the features, numbers, steps, actions, elements, parts, or combinations thereof disclosed in the specification, and are not intended to preclude the possibility that one or more other features, numbers, steps, actions, elements, parts, or combinations thereof may exist or may be added.

Also, if a component is described to be coupled to another component, the coupling not only refers to those cases where the components are in direct physical contact, but also encompasses those cases where a different element or elements are interposed between the components mentioned, with the components being in contact with the different element or elements respectively.

The light emitting diode unit according to certain embodiments of the invention will be described below in more detail with reference to the accompanying drawings. Those components that are the same or are in correspondence are rendered the same reference numeral regardless of the figure number, and redundant explanations are omitted.

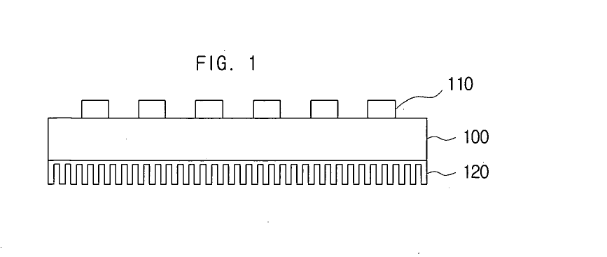

FIG. 1 is a sectional view showing a light emitting diode unit according to an embodiment of the present invention. Referring to FIG. 1, a thermoplastic substrate 100, a light emitting diode 110 and a heat sink 120 are shown.

The light emitting diode 110 can be mounted on the thermoplastic substrate 100 as a base. Conventionally, a thermosetting resin such as a phenol resin and an epoxy resin is typically used.

In an embodiment of the present invention, the thermoplastic substrate 100 can be made on a thermoplastic-resin basis. For example, the thermoplastic substrate 100 can be made based on a liquid crystal polymer, a Polyetherimide (PEI), a Polyethersulfone (PES), a Polyetheretherketone (PEEK) and a Polytetrafluoroethylene (PTFE). Alternatively, it is possible to make the thermoplastic substrate 100 based on a combination of the aforementioned materials.

In an embodiment of the present invention, the thermoplastic substrate 100 can be directly adhered to the heat sink 120. A thermoplastic substrate may have a low level of adhesion to the heat sink 120 made of a metal. This may require that an additional adhesive part is provided between the thermoplastic substrate and the heat sink 120 to allow the thermoplastic substrate and the heat sink 120 to adhere to each other. The use of the additional adhesive part may make it complex to manufacture the light emitting diode unit and cause the corresponding manufacture cost to be raised.

In an embodiment of the present invention, the light emitting diode unit can be formed by allowing the thermoplastic substrate 100 to be directly coupled to the heat sink 120 made of a metal, to thereby make the manufacture process simpler and the manufacture cost reduced as compared with the case of using the additional adhesive part.

The thermoplastic substrate 100 can include a circuit pattern for supplying an electric signal to the light emitting diode 110. The circuit pattern can be formed by allowing a copper foil to be stacked in the thermoplastic substrate 100 and patterning the copper foil. Otherwise, the circuit pattern can be formed by allowing a predetermined circuit pattern to be transferred on the thermoplastic substrate 100.

The light emitting diode 110 mounted on a substrate can be mold in a predetermined form. This molding can physically protect the light emitting diode 110 and support an electric connecting part provided for the light emitting diode. Since the present invention does not focus on the form of the molding, the form is not shown in FIG. 1.

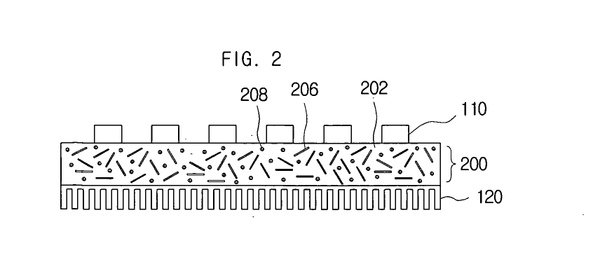

FIG. 2 is a sectional view showing a light emitting diode unit according to another embodiment of the present invention. Referring to FIG. 2, a thermoplastic substrate 200, a thermoplastic material 202, the light emitting diode 110, the heat sink 120, a glass fiber 206 and a ceramic filler 208 are shown.

The same description related to the light emitting diode 110 and the heat sink 120 as described with reference to FIG. 1 will be omitted.

In another embodiment of the present invention, the thermoplastic substrate 200 can include the thermoplastic material 202, the glass fiber 206 and the ceramic filler 208. The thermoplastic material 202 can be formed based on the thermoplastic-resin described in FIG. 1.

In another embodiment of the present invention, the thermoplastic substrate 200 can include the scattered ceramic fillers 208 therein. The ceramic filler 208 can be made by being included as ceramic powders in the thermoplastic resin constituting the thermoplastic substrate 200.

The ceramic filler 208 can decrease a thermal expansion coefficient of the thermoplastic substrate 200. This makes it possible to prevent the adhesion between the thermoplastic substrate 200 and the heat sink 120 from becoming weak due to the thermal expansion and to prevent the stability of the light emitting diode mounted on the thermoplastic substrate 200 from being destroyed due to thermal fatigue.

By adding the ceramic filler 208 having the good heat conduction, the heat transferred from the light emitting diode 110 can be more efficiently transferred to the heat sink 120. Herein, it is possible to use alumina, boron nitride and aluminum nitride, for example.

Adding the glass fiber 206 can allow the thermoplastic substrate 200 to physically become rigid enough. As shown in FIG. 2, the glass fiber 206 can be evenly scattered inside the thermoplastic material 202. As such, the glass fiber included inside the substrate can improve the rigidity of the substrate.

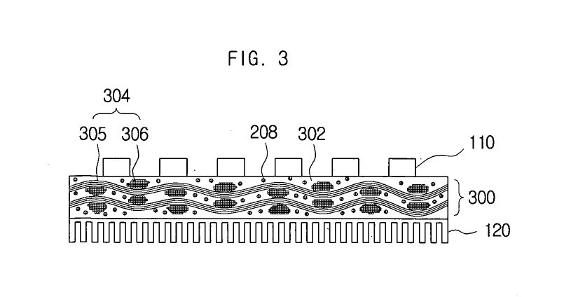

FIG. 3 is a sectional view showing a light emitting diode unit according to another embodiment of the present invention. Referring to FIG. 3, a thermoplastic substrate 300, a thermoplastic material 302, a glass fiber cloth 304, a weft 305, a warp 306, the ceramic filler 208, the light emitting diode 110 and the heat sink 120 are shown.

The same description related to the thermoplastic material 302, the light emitting diode 110 and the heat sink 120 as described with reference to FIG. 1 and/or FIG. 2 will be omitted.

In another embodiment of the present invention, the thermoplastic substrate 300 can have more improved rigidity by the thermoplastic material 302, formed on a thermoplastic-resin basis, and the glass fiber cloth 304, included in the thermoplastic material 302.

The glass fiber cloth 304 can be formed by the weave of the weft 305 and the warp 306 including a plurality of glass fiber twists. The ceramic filler 208 can be evenly scattered in the thermoplastic material 302 in order to improve the heat conduction of the thermoplastic substrate 300.

While the spirit of the invention has been described in detail with reference to particular embodiments, the embodiments are for illustrative purposes only and do not limit the invention. It is to be appreciated that those skilled in the art can change or modify the embodiments without departing from, the scope and spirit of the invention. As such, many embodiments other than those set forth above can be found in the appended claims.

What is claimed is:

1. A light emitting diode unit comprising:
a thermoplastic substrate;
a light emitting diode, mounted on one surface of the thermoplastic substrate; and
a heat sink, directly adhered to the other surface of the thermoplastic substrate.

2. The light emitting diode unit of claim 1, wherein the thermoplastic substrate is made based on one of a liquid crystal polymer, a Polyetherimide (PEI), a Polyethersulfone (PES), a Polyetheretherketone (PEEK) and a Polytetrafluoroethylene (PTFE) or a combination thereof.

3. The light emitting diode unit of claim 2, wherein the heat sink is made of a metal.

4. The light emitting diode unit of claim 2, wherein the thermoplastic substrate comprises scattered ceramic filters.

5. The light emitting diode unit of claim 2, wherein the thermoplastic substrate comprises scattered glass fibers.

6. The light emitting diode unit of claim 2, wherein the thermoplastic substrate comprises a glass fiber cloth formed by a weave of a weft and a warp including a plurality of glass fiber twists.
